(19) United States
(12) Patent Application Publication
(10) Pub. No.: US 2026/0296091 A1
(43) Pub. Date: Oct. 1, 2026

(54) SKULL SUPPORTS FOR SUPPORTING A SKULL

(71) Applicants: Timothy Herz, Vancouver, WA (US); Michael Herz, Vancouver, WA (US)

(72) Inventors: Timothy Herz, Vancouver, WA (US); Michael Herz, Vancouver, WA (US)

(21) Appl. No.: 19/091,583

(22) Filed: Mar. 26, 2025

(51) Int. Cl. B44C 5/02; F16M 13/02

(52) U.S. Cl. CPC B44C 5/02; F16M 13/02; F16M 2200/06

(57) ABSTRACT

Skull supports for supporting a skull. The skull supports include a base, an arm, and a stem. The base is configured to mount to a vertical support member. The arm extends from the base and is disposed below a skull supported on the skull support. The stem extends from the base at an angle away from the arm and spaced from the arm. The stem is configured to insert into a foramen magnum of a skull supported on the skull support.

### BACKGROUND

The present disclosure relates generally to display members. In particular, skull supports for displaying and supporting a skull are described.

Hunters and those who appreciate animals generally often enjoy displaying animal skulls. For hunters, the animal skulls displayed may be animals that they successfully hunted. Others may display animal skulls they find interesting.

Skulls may be displayed in a variety of ways. For example, one may simply place an animal skull on a shelf or desk surface. Alternatively, stands exists for supporting an animal skull above a horizontal surface like a tabletop, shelf, or desktop. Supports configured to secure to a wall or other vertical member also exist.

Conventional skull supports are not entirely satisfactory. For instance, conventional skull supports do not support skulls with sufficient stability. Further, conventional skull supports do not adequately enable supporting a skull at different angles. Moreover, conventional skull supports do not utilize the foramen magnum of a skull to secure the skull.

Thus, there exists a need for skull supports that improve upon and advance the design of known skull supports. Examples of new and useful skull supports relevant to the needs existing in the field are discussed below.

### SUMMARY

The present disclosure is directed to skull supports for supporting a skull from a vertical member, such as a wall, door, tree, or post of a stand. The skull supports include a base, an arm, and a stem.

The base is configured to mount to a vertical support member. The arm extends from the base and is disposed below a skull supported on the skull support.

The stem extends from the base at an angle away from the arm and spaced from the arm. The stem is configured to insert into a foramen magnum of a skull supported on the skull support.

### BRIEF DESCRIPTION OF THE DRAWINGS

FIG. 1 is a perspective view of a first example of a skull support supporting an animal skull with a stem of the skull support inserted into a foramen magnum of the skull.

FIG. 2 is a front elevation view of the skull support shown in FIG. 1.

FIG. 3 is a left side elevation view of the skull support shown in FIG. 1.

FIG. 4 is a top view of the skull support shown in FIG. 1.

FIG. 5 is a bottom view of the skull support shown in FIG. 1.

FIG. 6 is a side perspective detail view of a plate of the skull support secured to an arm via a coupler inserted through a slot defined in the plate and an opening defined in the arm that is aligned with the slot and coupler.

FIG. 7 is a rear view of the skull support shown in FIG. 1.

### DETAILED DESCRIPTION

The disclosed skull supports will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various skull supports are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Contextual Details

Ancillary features relevant to the skull supports described herein will first be described to provide context and to aid discussing the skull supports.

### Skull

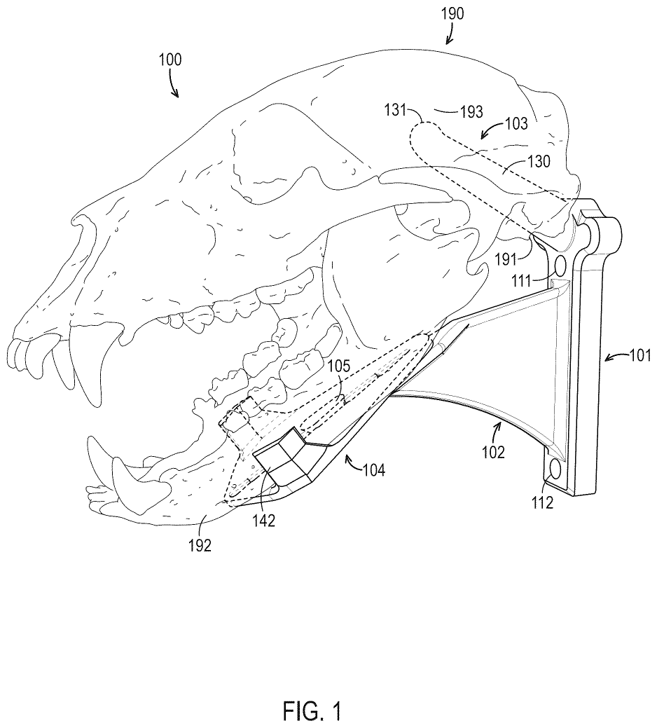

The skull supports described in this document function to support skulls for display purposes. One suitable skull, skull 190, is depicted supported on a skull support 100 in FIG. 1.

Often, the skulls displayed on the skull supports will be animal skulls. However, human or hominid skulls may be displayed on the skulls supports as well. The skulls displayed on the skull supports may be from previously living animals or may be replicas.

In the example shown in FIG. 1, skull 190 is a bear skull. However, the skull may be any type of animal or hominid species. Deer, elk, moose, cougar, and other animals that sportsmen hunt are often selected for display on the skull supports. The skulls may be larger or smaller than skull 190 depicted in FIG. 1.

Skull 190 includes a foramen magnum 191 at the back of the skull, a jaw 192 at the bottom of the skull, and an internal top 193 at the top of a cranial cavity of the skull. Foramen magnum 191 is an opening in skull 190 through which a spinal cord passed through from the spine. As explained further below, a stem 103 of skull support 100 passes through foramen magnum 191 and supports skull 190 in part from foramen magnum 191 and from internal top 193.

Different animals will have different sized foramen magnums. Stem 103 is tapered to accommodate different sized foramen magnums. Further, the foramen magnums may be higher or lower on the back of the skull depending on the animal. The angle at which stem 103 extends enables stem 103 to insert into foramen magnums in a variety of higher and lower positions at the back of the skull for different animals.

### Vertical Support Member

The skull supports described in this document selectively mount to vertical support members when supporting a skull. The skull supports may mount to a variety of vertical support members, such as walls, doors, or trees.

Another example of a vertical support member to which the skull supports may mount is a post of a stand resting on horizontal surface. For example, the skull supports described herein may selectively mount to a post of a stand resting on a desktop, tabletop, or shelf.

### Skull Supports for Supporting a Skull

With reference to the figures, skull supports for supporting a skull will now be described. The skull supports discussed herein function to support a skull from a vertical member, such as a wall, door, tree, or post of a stand.

The reader will appreciate from the figures and description below that the presently disclosed skull supports address many of the shortcomings of conventional skull supports. For example, the novel skull supports described herein support skulls with stability from multiple support points. Beneficially, the novel skull supports are effective to stably support skulls of a wide variety of animals.

Advantageously, the novel skull supports enable supporting a skull at different angles. For example, one can use the novel skull supports to support an animal skull at a desired amount of vertical tilt. Further, the novel skull supports enable supporting the skull with the jaw maintained open or closed.

Importantly, the novel skull supports utilize the foramen magnum of a skull to secure the skull on the skull support. Supporting a skull via the foramen magnum enables the novel skull support to support the skull with more stability because the skull is supported from 360 degrees within the foramen magnum opening. Further, supporting a skull via the foramen magnum makes the novel skull supports easy to use and more universally applicable to a wide variety of animal skulls. Utilizing the foramen magnum causes the novel skull supports to support skulls from multiple support points, which increases the stability of the skull on the skull support and provides more flexibility in how the skull is displayed on the skull support.

### Skull Support Embodiment One

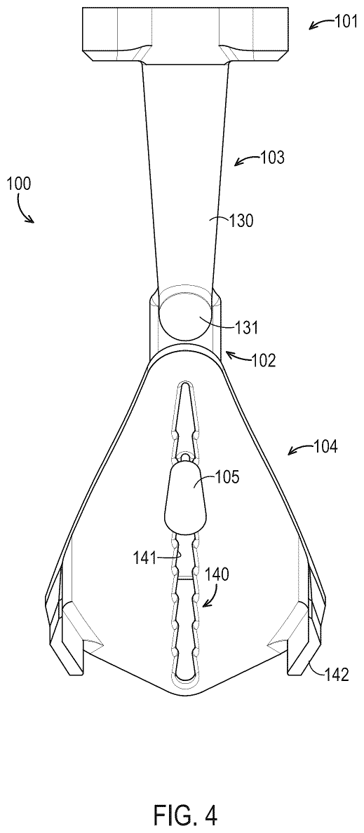

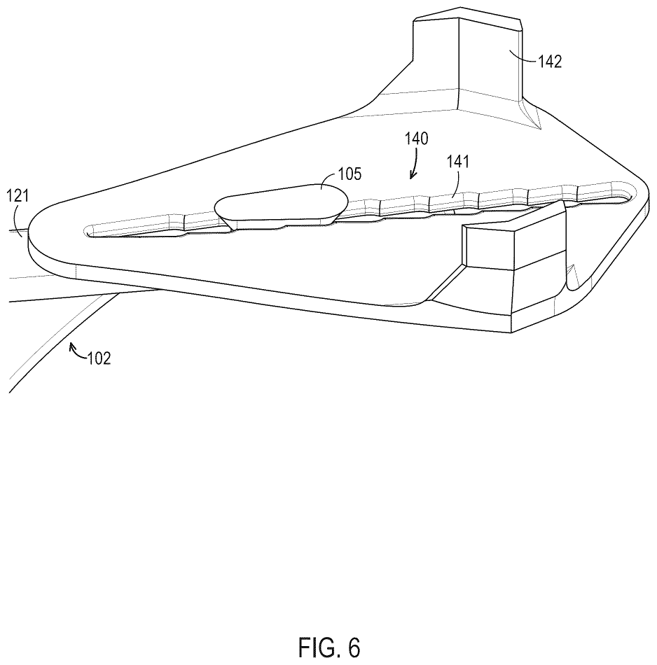

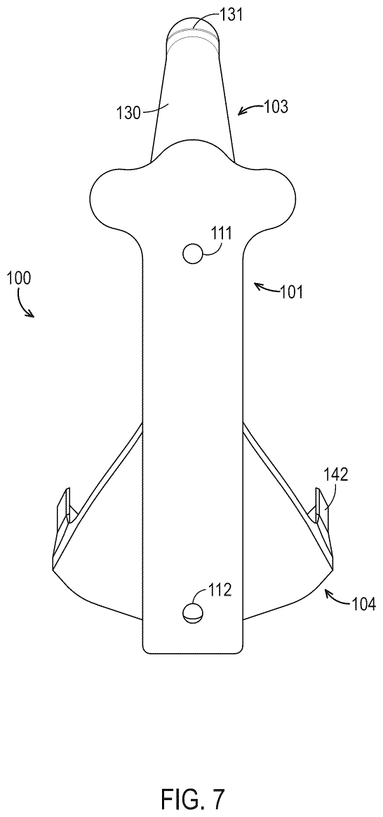

With reference to FIGS. 1-7, a first example of a skull support, skull support 100, will now be described. Skull support 100 includes a base 101, an arm 102, a stem 103, a plate 104, and a coupler 105. The components of skull support 100 are described further in the sections below.

In some examples, the skull support does not include one or more features included in skull support 100. For example, some skull support examples do not include a plate and/or a coupler. In certain examples, the skull support includes additional or alternative features.

The size of the skull support may be larger or smaller than the skull than skull support 100 shown in FIG. 1. The shape of the skull support may vary in different examples while maintaining its core components and functions.

In the example shown in FIGS. 1-7, skull support 100 is primarily composed of metal. However, the skull support may be formed from other materials in other examples, such as polymers, wood, metals, composite materials, and combinations thereof.

### Base

Base 101 functions to selectively couple skull support 100 to a vertical member, such as a wall, door, tree, or post of a stand. Further, base 101 supports other components of skull support 100, such as arm 102 and stem 103.

Base 101 configured to mount to a vertical member via fasteners passing through openings formed in base 101 and fastening to the vertical member. The vertical member may be a wall, a door, a tree, a post of stand, or any other vertical member to which the base may securely fasten. As shown in FIGS. 1, 2, and 7, base 101 defines a first fastener hole 111 and a second fastener hole 112.

First fastener hole 111 is disposed between arm 102 and stem 103. Second fastener hole 112 is vertically spaced from first fastener hole 111. In particular, second fastener hole 112 is disposed below arm 102 and first fastener hole 111 is disposed above arm 102.

First fastener hole 111 is configured to receive a first fastener, and second fastener hole 112 is configured to receive a second fastener. Each fastener passing through fastener holes 111 and 112 function to selectively mount base 101 to a vertical member. The fasteners may be screws, nails, bolts, or other suitable mechanical fasteners.

### Arm

Arm 102 functions to support plate 104, which supports skull 190 from below. The shape and orientation of arm 102 facilitates supporting skull 190 with jaw 192 open or closed.

As shown in FIGS. 1-5, arm 102 extends from base 101. Arm 102 extends from base 101 from a position disposed between first fastener hole 111 and second fastener hole 112. FIG. 1 makes apparent that arm 102 is disposed below skull 190 when skull 190 is supported on skull support 100.

As depicted in FIGS. 1-4, arm 102 includes a sloped portion 121. Sloped portion 121 is disposed distal base 101. Arm 102 selectively supports plate 104 on sloped portion 121, which orients plate 104 at an angle or slope conducive to supporting jaw 192 of skull 190.

The reader can see in FIGS. 1-6 that sloped portion 121 of arm 102 supports plate 104 from below when coupler 105 selectively couples plate 104 to arm 102. Plate 104 may extend beyond arm 102 when supported on sloped portion 121 of arm 102. Plate 104 may be positioned on and coupled to arm 104 at various positions with varying amounts of extension beyond arm 104. The ability to selectively couple plate 104 to arm 102 in various positions enables plate 104 and arm 102 to support skulls of various sizes and at various angles.

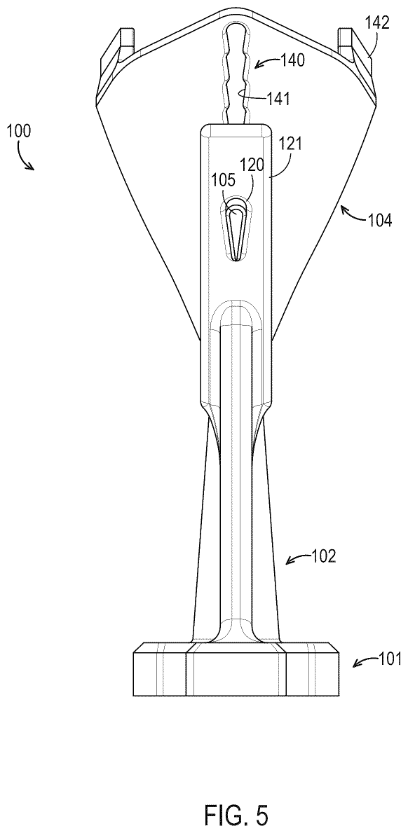

FIG. 5 demonstrates that sloped portion 121 of arm 102 defines an opening 120. Opening 120 is complementarily configured with regions of a slot 140 of plate 104 and with coupler 105. In the example shown in the figures, opening 120 and coupler 105 have teardrop shapes and slot 140 defines partial teardrop regions 141. However, the opening, the slot regions, and the coupler could have other complementarily shapes in other examples.

Opening 120 is configured to selectively receive coupler 105. Coupler 105 and opening 120 have a relative size tolerance selected to restrict coupler 105 from moving longitudinally or laterally within opening 120. Opening 120 restricts coupler 105 from moving longitudinally or laterally when coupler 105 extends through a selected partial teardrop region 141 of slot 140 and inserts into opening 120. The position of plate 104 relative to arm 102 is set when coupler 105 inserts into a selected partial teardrop region 141 aligned with opening 120.

### Stem

Stem 103 functions to support skull 190 from within foramen magnum 191 of skull 190. Cranial cavity top 193 of skull 190 may rest on a tip 131 of stem 103 as well.

As shown in FIGS. 1-3, stem 103 extends from base 101 from a position on base 101 spaced from arm 102. FIGS. 1-3 demonstrate that stem 103 extends from base 101 at an upward angle relative to arm 102.

With reference to FIG. 1, the reader can see that stem 103 is configured to insert into foramen magnum 191 of skull 190 when skull 190 is supported on skull support 100. Foramen magnum 191 rests on stem 103, and skull 190 is restricted from moving laterally or vertically by interference between foramen magnum 191 and stem 103. In the present example, cranial cavity top 131 within the cranial cavity rests on a tip 131 of stem 103. For some skull shapes and sizes, the tip of the stem is spaced from the cranial cavity top.

As depicted in FIGS. 1-4 and 7, stem 103 includes a shaft 130 and a tip 131. Tip 131 is disposed on an end of shaft 130 distal base 101 and is spaced from base 101.

In the present example, tip 131 projects vertically from shaft 130 at an angle and is rounded. In other examples, the tip does not project at an angle from the shaft, but instead is inline with the shaft. In certain examples, the tip is not rounded, but is flat, angular, or pointed. Tip 131 projecting vertically with a round profile facilitates cranial cavity top 193 of a skull resting on tip 131 within the skull or cranial cavity.

The reader can see in FIGS. 1-4 and 7, that shaft 130 radially tapers as it extends away from the base. The radial taper of shaft 130 facilitates it inserting into foramen magnums of various sizes and shapes. Further, the radial taper of shaft 130 enables foramen magnum 191 to abut and rest on a wider diameter portion of shaft 130 that corresponds with the opening size of foramen magnum 191. The size correspondence between the wider diameter portion of shaft 130 and foramen magnum 191 causes shaft 130 to helpfully resist skull 190 moving laterally or vertically due to interference between shaft 130 and foramen magnum 191.

### Plate

Plate 104 functions to support skull 190 from below. Plate 104 cooperates with arm 102 and coupler 105 to adjust the overall length of the collective support member defined by plate 104 and arm 102 underneath skull 190.

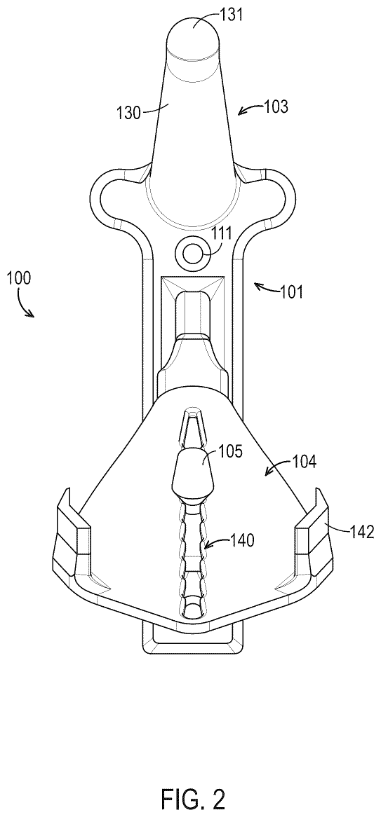

As shown in FIGS. 2-6, plate 104 selectively couples to arm 102 via coupler 105. In particular, plate 104 rests on sloped portion 121 of arm 102 when coupler 105 selectively couples plate 104 to arm 102.

Plate 104 maintains the slope established by sloped portion 121 when plate 104 mounts flat onto sloped portion 121. In some examples, the plate is mounted to the sloped portion at an angle rather than flat, which causes the plate to extend from the sloped portion at a different angle or slope than the sloped portion. For example, the plate may be coupled to the arm at an angle relative to the sloped portion to raise the level of support to the jaw of the skull higher than would be provided if the plate maintained the slope of the sloped portion.

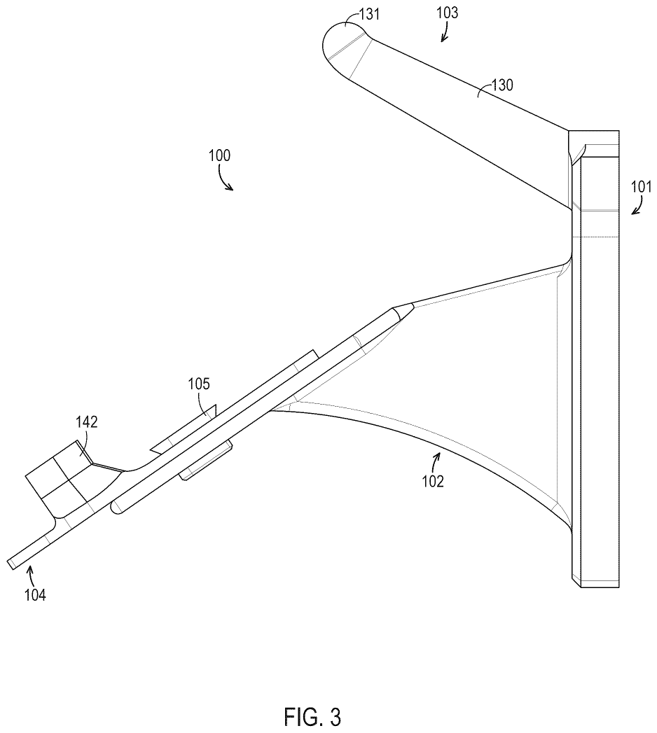

FIGS. 3 and 5 demonstrate that plate 104 may extend beyond arm 102 when supported on sloped portion 121 of arm 102. Plate 104 may be positioned on and coupled to arm 102 at various positions with varying amounts of extension beyond arm 102. The ability to selectively couple plate 104 to arm 102 in various positions enables plate 104 and arm 102 to support skulls of various sizes and at various angles.

With reference to FIGS. 2 and 4-6, the reader can see that plate 104 defines a slot 140. Slot 140 extends medially along a major portion of a length of plate 104 and defines a series of partial teardrop regions 141. Partial teardrop regions 141 are complementarily configured with the size and shape of coupler 105 to selectively receive coupler 105 in a selected partial teardrop region 141. The partial teardrop shape of partial teardrop regions 141 complementing the teardrop shape of coupler 105 restricts the coupler from moving longitudinally or laterally within slot 140.

Slot 140 cooperates with coupler 105 and opening 120 in arm 102 to selectively couple plate 104 to arm 102 with plate 104 extending beyond arm 102 to a selected extent. Plate 104 selectively couples to arm 102 in a desired position when coupler 105 extends through a selected partial teardrop region 141 of slot 140 and inserts into opening 120 of arm 102. The position of plate 104 relative to arm 102 is set when coupler 105 inserts into partial teardrop region 141 aligned with opening 120.

As shown in FIGS. 1-7, plate 104 includes front supports 142 configured to contain a jaw 192 of skull 190 when skull 190 rests on plate 104. Front supports 142 project from opposite lateral sides of plate 104. In particular, as shown in FIGS. 1-7, front supports 142 extend around lateral and front portions of plate 104. Front supports 142 extending around lateral and front portions of plate 104 restricts skull 190 from moving laterally and forward beyond plate 104 due to interference between front supports 142 and jaw 192.

### Coupler

Coupler 105 functions to secure plate 104 to arm 102 in a desired position. Coupler 105 interacts with slot 140 and opening 120 to restrict plate 104 from moving laterally or longitudinally relative to arm 102.

As shown in FIGS. 2-6, coupler 105 inserts through slot 140 and opening 120 of arm 102 to couple plate 104 to arm 102. In particular, coupler 105 extends through a selected partial teardrop region 141 of slot 140 and inserts into opening 120 of sloped portion 121. The position of plate 104 relative to arm 102 is set when coupler 105 inserts into a selected partial teardrop region 141 aligned with opening 120.

As is apparent from FIGS. 2-6, coupler 105 is complementarily configured with each partial teardrop region 141 of slot 140 and with opening 120. Coupler 105 has a teardrop shape adapted to fit within the teardrop shape of opening 120 and the partial teardrop shape of partial teardrop regions 141. However, the opening, the slot regions, and the coupler could have other complementarily shapes in other examples.

Coupler 105 and opening 120 have a relative size tolerance selected to restrict coupler 105 from moving longitudinally or laterally within opening 120. Opening 120 restricts coupler 105 from moving longitudinally or laterally when coupler 105 extends through a selected partial teardrop region 141 of slot 140 and inserts into opening 120. In turn, coupler 105 restricts plate 104 from moving laterally or longitudinally when coupler 105 inserts into selected partial teardrop region 141 and opening 120.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A skull support for supporting a skull, comprising:
a base configured to mount to a vertical support member;
an arm extending from the base and disposed below a skull supported on the skull support; and
a stem extending from the base at an angle away from the arm and spaced from the arm, the stem configured to insert into a foramen magnum of a skull supported on the skull support.

2. The skull support of claim 1, wherein the base defines a first fastener hole configured to receive a first fastener selectively mounting the base to a vertical support member.

3. The skull support of claim 2, wherein the base defines a second fastener hole vertically spaced from the first fastener hole and configured to receive a second fastener selectively mounting the base to a vertical support member.

4. The skull support of claim 3, wherein the first fastener hole is disposed between the arm and the stem.

5. The skull support of claim 4, wherein the arm is disposed between the first fastener hole and the second fastener hole.

6. The skull support of claim 1, further comprising a plate selectively coupled to the arm.

7. The skull support of claim 6, wherein the plate defines a slot.

8. The skull support of claim 7, wherein the slot extends medially along a major portion of a length of the plate.

9. The skull support of claim 8, wherein the arm defines an opening.

10. The skull support of claim 9, further comprising a coupler configured to secure the plate to the arm by inserting through the slot and the opening.

11. The skull support of claim 10, wherein the coupler is configured to secure the plate in a desired longitudinal position relative to the arm by passing through a selected portion of the slot aligned with the opening when the plate is longitudinally adjusted to the desired longitudinal position.

12. The skull support of claim 11, wherein the opening, the slot, and the coupler are complementarily configured.

13. The skull support of claim 12, wherein:
the opening has a teardrop shape;
the coupler has a teardrop shape adapted to fit within the opening; and
the coupler and the opening have a relative size tolerance selected to restrict the coupler from moving longitudinally within the opening.

14. The skull support of claim 13, wherein the slot defines a series of partial teardrop regions each configured to receive the coupler and to restrict the coupler from moving longitudinally within the slot.

15. The skull support of claim 14, wherein the selected portion of the slot is one of the partial teardrop regions defined by the slot.

16. The skull support of claim 6, wherein:
the plate includes front supports projecting from opposite lateral sides of the plate; and
the front supports are configured to contain a jaw of a skull on the plate.

17. The skull support of claim 16, wherein the front supports extend around lateral and front portions of the plate in positions that restrict a skull supported on the plate from moving laterally and forward beyond the plate.

18. The skull support of claim 6, wherein the plate extends beyond the arm when selectively coupled to the arm.

19. The skull support of claim 18, wherein:
the arm includes a sloped portion distal the base;
the plate selectively couples to the sloped portion; and
the plate is sloped when selectively coupled to the sloped portion of the arm.

20. The skull support of claim 1, wherein the stem radially tapers as it extends away from the base.
